(19) United States
(12) Patent Application Publication
(10) Pub. No.: US 2024/0240554 A1
(43) Pub. Date: Jul. 18, 2024

(54) TRAINING DATASET GENERATION PROCESS FOR MOMENT TENSOR MACHINE LEARNING INVERSION MODELS

(71) Applicant: Saudi Arabian Oil Company, Dhahran (SA)

(72) Inventors: Diego Rovetta, Delft (NL); Daniele Colombo, Dhahran (SA); Eddy Revelo Obando, Delft (NL); Ersan Turkoglu, Dhahran (SA)

(21) Appl. No.: 18/096,402

(22) Filed: Jan. 12, 2023

(51) Int. Cl. E21B 47/18; G01V 1/28

(52) U.S. Cl. CPC E21B 47/18; G01V 1/282; E21B 2200/22

(57) ABSTRACT

Methods and systems for training a machine learning model to process microseismic data recorded during fracturing of a subterranean geological formation are configured for selecting a volume in the subterranean geological formation, the volume comprising a set of vertices and a center, the set of vertices defining a first dimension; determining seismogram data for sources at the vertices of the volume and at the center of the volume; generating training data from the seismogram data, the training data relating values of seismogram data to values of moment tensor components; training a machine learning model using the training data; and determining, based on the trained machine learning model, a second dimension defined for the set of vertices, the second dimension being a maximum value enabling an accuracy for outputs of the trained machine learning model that satisfies a threshold.

### TECHNICAL FIELD

The present disclosure generally relates to seismic attributes for reservoir characterization. Specifically, this application relates to generating training data for training machine learning models that process seismic data for a geological region.

### BACKGROUND

Hydraulic fracturing is a process in which fluids are injected into a borehole to fracture a subsurface region. The fractures in the subsurface enable fluids, such as hydrocarbons (oil, gas, etc.) to flow from the subsurface and into the well for pumping to the surface.

Analysis of microseismic measurements acquired during borehole acquisition surveys enables a thorough understanding of the source mechanism during hydraulic fracturing operations. Due to the injection of high-pressure fluids, induced fractures produce low magnitude seismic events that can be recorded and subsequently analyzed to infer the stress field at the source locations. The components of the seismic moment tensor are used to describe general seismic sources as it can provide information about the type of motion and the distribution of forces.

### SUMMARY

This disclosure describes methods and systems for analysis of microseismic measurements. The microseismic measurements are acquired during borehole acquisition surveys. A data processing system is configured to estimate values of the components of the seismic moment tensor from data that are recorded during fracturing. The data processing system performs the estimation based on machine learning models, rather than deterministically. The data processing system generates training data for these machine learning models, as subsequently described. The generation of training data with sufficient data is an important step for use of machine learning in this context. The use of machine learning models (such as neural networks) significantly improves monitoring operations and provides data that the data processing system uses to determine a structure of the reservoir, as subsequently described.

Several challenges are associate with acquisition of microseismic borehole measurements. Microseismic borehole measurements are characterized by a low signal-to-noise ratio (SNR) values. Microseismic data are associated with a limited angle coverage. These properties ultimately affect the deterministic inversion predictions about the location and the source mechanism of the events induced by fracturing.

Analysis techniques can be based on the use of machine learning (ML) to perform the moment tensor inversion. A data processing system can execute a forward modeling code to simulate microseismic data generated by known values of the moment tensor components at the source location (also called the forward problem). The data processing system uses the generated data as training data to train an artificial neural network (ANN). The data processing system estimates, from the trained ANN, a value of the moment tensor at the source, given the measured microseismic data at the seismic receivers (also called the inverse problem).

These previously described techniques require a sufficient amount of information to be extracted from the training dataset and used by the ANN during the prediction phase for providing the moment tensor estimate. For example, there are no procedures explaining how to generate such a dataset in an efficient way, especially in presence of complex heterogeneous velocity models.

To overcome these issues, this disclosure describes a process to efficiently generate a training dataset with a sufficient amount of information to allow the trained ANN to estimate moment tensor components from microseismic data. The processes and systems described in this disclosure can be used for other application fields in which an optimal spatial distribution of an attribute used for machine learning training are automatically determined.

The described implementations can provide various technical benefits. The data processing system enables machine learning models to be applied to microseismic data to determine the moment tensor for those data. Determination of the moment tensor enables a better determination of a structure of a subsurface near a borehole for fracking operations. The improved understanding of the structure of the subsurface can enable improved control of fracking operations and improved yields from associated wells in the mapped subsurface.

One or more of the various technical benefits are enabled by the following embodiments.

In an aspect, a process for generating a training dataset enables a machine learning model to estimate moment tensor components from microseismic data. The process for training a machine learning model to process microseismic data recorded during fracturing of a subterranean geological formation includes selecting a volume in the subterranean geological formation, the volume comprising a set of vertices and a center, the set of vertices defining a first dimension. The process includes determining seismogram data for sources at the vertices of the volume and at the center of the volume. The process includes generating training data from the seismogram data, the training data relating values of seismogram data to values of moment tensor components. The process includes training a machine learning model using the training data. The process includes determining, based on the trained machine learning model, a second dimension defined for the set of vertices, the second dimension being a maximum value enabling an accuracy for outputs of the trained machine learning model that satisfies a threshold.

The process includes acquiring microseismic data during a borehole acquisition survey associated with a given subterranean formation. The process includes executing the trained machine learning model on the microseismic data. The process includes generating an estimate of the values of the components of the moment tensor components for the given subterranean formation associated with the borehole acquisition survey.

The process includes generating a seismic interpretation based on the estimate of the values of the moment tensor components. The process includes drilling a well in the given subterranean formation or performing hydraulic fracturing in the given subterranean formation based on the estimate of the values of the moment tensor components.

The process includes generating training data from the seismogram data comprises simulating seismic wave propagation from the sources to the receivers for one or more known values of the moment tensor components.

The process includes training the machine learning model using the training data comprises setting weight values of nodes represented in a neural network of the machine learning model.

In a general aspect, a system for training a machine learning model to process microseismic data recorded during fracturing of a subterranean geological formation includes at least one processor; and a memory storing instructions that, when executed by the at least one processor, cause the at least one processor to perform operations comprising the processes described previously and in this specification.

In a general aspect, one or more non-transitory computer-readable media storing instructions for training a machine learning model to process microseismic data recorded during fracturing of a subterranean geological formation, the instructions, when executed by at least one processor, cause the at least one processor to perform operations comprising the processes described previously and in this specification.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of a seismic survey being performed to map subterranean features such as facies and faults.

FIG. 2 illustrates a three-dimensional (3D) cube representing a subterranean formation.

FIG. 3 illustrates a flow diagram including an example process for optimize the sources distribution for generation of machine learning training data.

FIG. 4 is a block diagram of an example system.

FIG. 5 is a representation of reduction in a cube dimension based on execution of the process of FIG. 3.

FIG. 6 shows borehole seismic acquisition geometry with a horizontal well.

FIG. 7 shows the results of the predicted six-independent moment-tensor components.

FIG. 8 shows an example process for generating a training dataset enabling a machine learning model to estimate moment tensor components from microseismic data.

FIG. 9 is a diagram of an example computing system.

### DETAILED DESCRIPTION

This specification describes processes and systems configured for automatic and efficient generation of a machine learning model (ANN) training dataset. The machine learning model training dataset are used as input data to train the machine learning model to generate a prediction of moment tensor components from seismic data during hydraulic fracturing operations. The processes described in this specification describe a generation of the ANN training dataset that enables a prediction of moment tensor components from seismic data during hydraulic fracturing operations in an efficient and automatic manner.

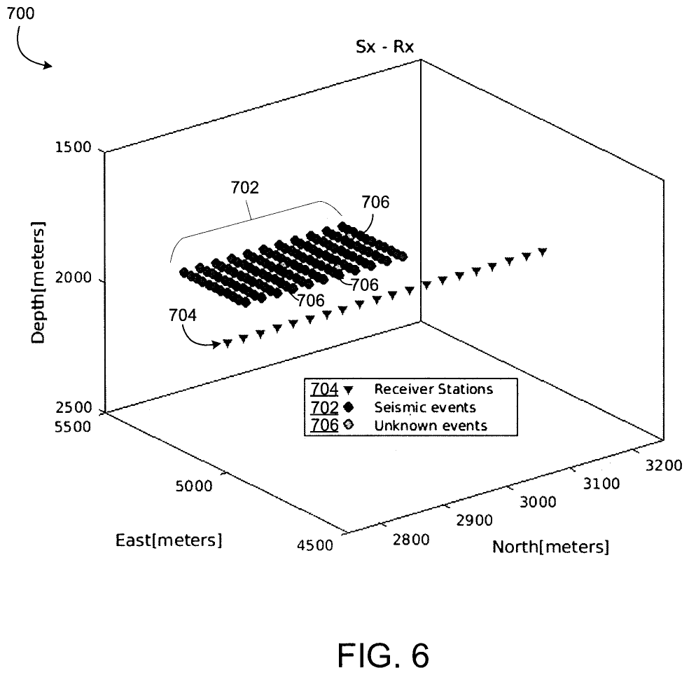

The data processing system is configured to generate the ANN training dataset in that includes new data that are not otherwise available. Specifically, the data processing system generates synthetic microseismic data, which cannot be manually generated. The approach described herein increases efficiency in comparison to existing ANN based methods, in which a system simulates seismic wave propagation for a very dense grid of source points. The described processes in this specification reduce a number of needed simulations to a minimum number that provide an accuracy above a threshold level for the moment tensor components estimation. For example, for a complex propagation model, the system “builds” a grid of sources to generate microseismic data for the ANN training every 25 meters in two dimensions (X and Y directions). To cover an area of 300 m×300 m around the reservoir (e.g., shown in FIG. 6), 144 sources would be needed, and 144 simulations executed, to generate synthetic data. The processes described in this specification reduce the number of sources and simulations performed. For example, given a tolerance on the accuracy of the prediction as subsequently described, the data processing system reduces the number of sources by spacing them every 50 m in X and Y, instead of 25 m. The data processing system uses 36 sources and performs 36 simulations, reducing the computational cost by 75%. This number is subject to change, because computational improvement depends on the complexity of the propagation model and is case dependent. For example, greater improvements than 75% are possible.

The data processing system is configured to generate training data compatible with complex heterogeneous velocity models. The data processing system is configured to use the training data to train a machine learning model to inverting the moment tensor components from seismic data. This approach is more accurate than methods in which inversion of moment tensor components is performed based on deterministic or Bayesian inversions.

The processes described in this specification are more accurate than deterministic inversion in presence of low signal-to-noise ratio measurements and of limited angle coverage of the typical borehole acquisitions. The computational cost reduction is significant (e.g., over 70%). For example, execution of a deterministic Bayesian inversion for a complex model takes time (hours or days). Once the training is completed, the moment tensor estimation with ANN is practically instantaneous. The training phase computational cost is reduced by these processes. The moment tensor components at the microseismic event locations can be used by the interpreters to understand the trend of the fractures during hydraulic fracturing operations.

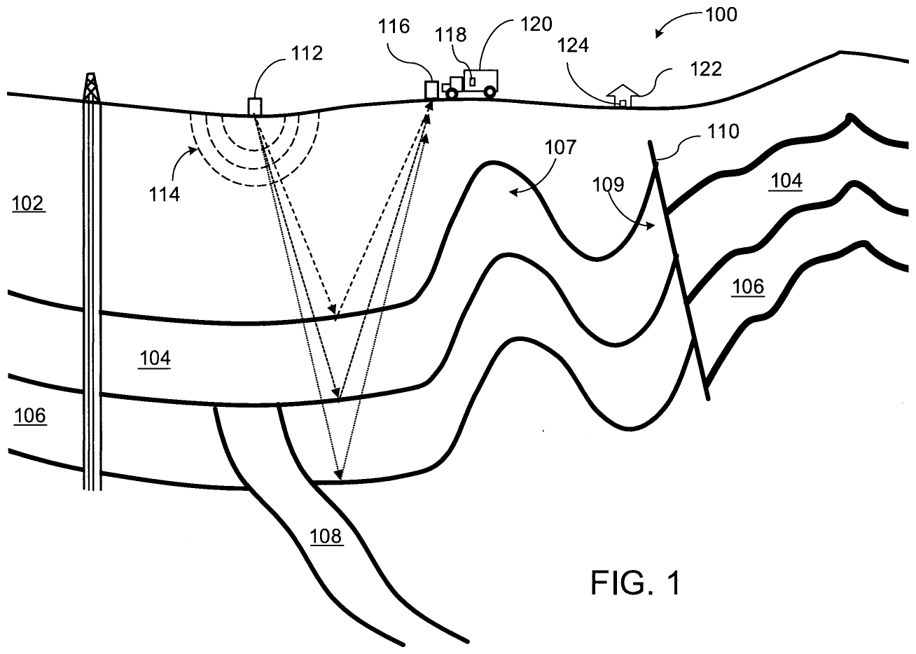

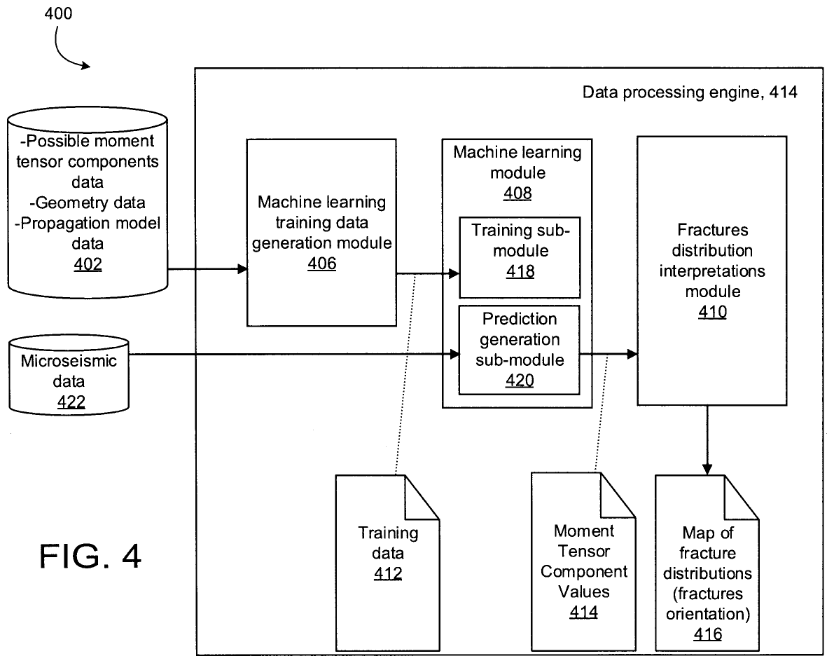

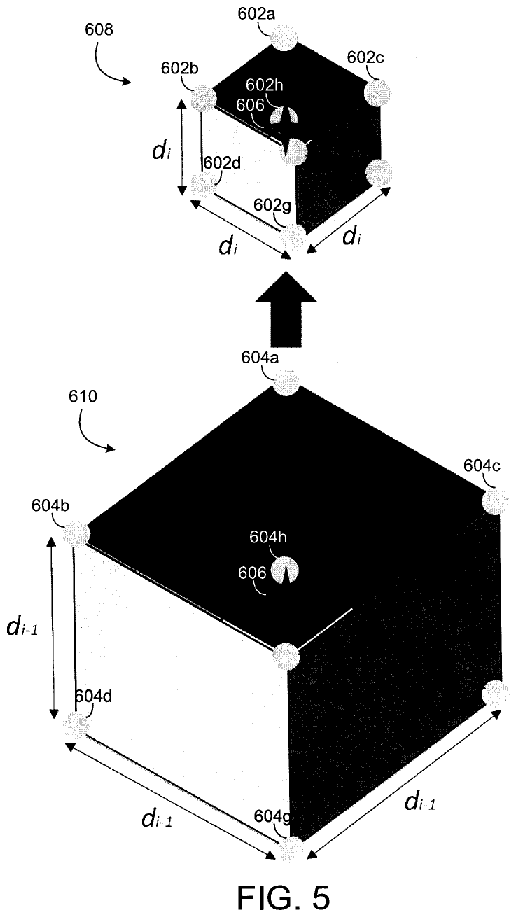

FIG. 1 is a schematic view of a seismic survey being performed to map subterranean features such as facies and faults in a subterranean formation 100. The seismic survey provides the underlying basis for implementation of the systems and methods described with reference to FIGS. 4-5. The subterranean formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow along with clay material between the walls traps the petroleum. Other traps include salt domes and stratigraphic traps.

A seismic source 112 (for example, a seismic vibrator or an explosion) generates seismic waves 114 that propagate in the earth. The velocity of these seismic waves depends on several properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic waves 114 contact interfaces between geologic bodies or layers that have different velocities, the interfaces reflect some of the energy of the seismic wave and refracts some of the energy of the seismic wave. Such interfaces are sometimes referred to as horizons.

In some implementations, the seismic source can be explosions or other events associated with hydraulic fracturing (fracking). For example, as fluid are used to fracture rock in the subsurface, vibrations are generated. These events can be used as seismic sources to map the subsurface as described herein.

The seismic waves 114 are received by a sensor or sensors 116. Although illustrated as a single component in FIG. 1, the sensor or sensors 116 are typically a line or an array of sensors 116 that generate output signals in response to received seismic waves including waves reflected by the horizons in the subterranean formation 100. The sensors 116 can be geophone-receivers that produce electrical output signals transmitted as input data, for example, to a computer 118 on a seismic control truck 120. In some implementations, the computer 118 can be in a building or other structure 122 that is remote from the subterranean formation. Based on the input data, the computer 118 may generate a seismic data output, for example, a seismic two-way response time plot. Generally, the computer 118 includes a seismic imaging system 250 described in relation to FIG. 5. The seismic imaging system 250 of the computer is configured to receive the seismic data from the sensors 116 and a velocity module of seismic waves 114 generated by the source(s) 112. The seismic imaging system is configured to generate a seismic image representing the path(s) of the seismic waves 114 through the subterranean formation 100, specifically with respect to near surface locations (less than 100 feet deep) in the formation.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. In some implementations, the control center 122 includes the seismic imaging system 250. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer system 124 may be displayed for user viewing using local or remote monitors or other display units. One approach to analyzing seismic data is to associate the data with portions of a seismic cube representing the subterranean formation 100. The seismic cube can also be display results of the analysis of the seismic data associated with the seismic survey.

Seismic attributes are often considered a key tool to aid in the spatial identification of reservoir features and rock properties that may otherwise be difficult to ascertain from direct observation of the seismic amplitude cube. For example, a data processing system uses acoustic impedance data to determine rock porosity and to control a spatial distribution in 3D porosity modeling.

The data processing system can determine acoustic impedance data based on the acquired seismic data form the seismic survey. Acoustic impedance is a layer property of a rock and it is equal to the product of compressional velocity and density. Seismic traces are converted into pseudo-reflection-coefficient time series by appropriate initial processing, then into acoustic impedance by the inversion of the time series. Such pseudo-logs are roughly equivalent to logs recorded in wells drilled at every seismic trace location. The pseudo-logs include data that describes the subsurface rock and variations in rock lithology. To obtain the best quality pseudo-logs, the data processing system performs preprocessing of the seismic data such as true-amplitude recovery, appropriate deconvolution, common-depth-point (CDP) stack, wave-shaping, wave-equation migration, and amplitude scaling. The low frequencies from moveout velocity information are inserted. Both the short-period information computed from reflection amplitudes and the long-period trend computed from reflection moveout are displayed on acoustic impedance logs. Possible causes of pseudo-log distortions are inaccuracies of amplitude recovery and scaling, imperfection of deconvolution and migration, and difficulties of calibrating the pseudo-log to an acoustic log derived from well logs. Such calibration increases the precision. Facies variations observed in well logs can be extrapolated to large distances from the wells, leading to a more accurate estimation of hydrocarbon reserves.

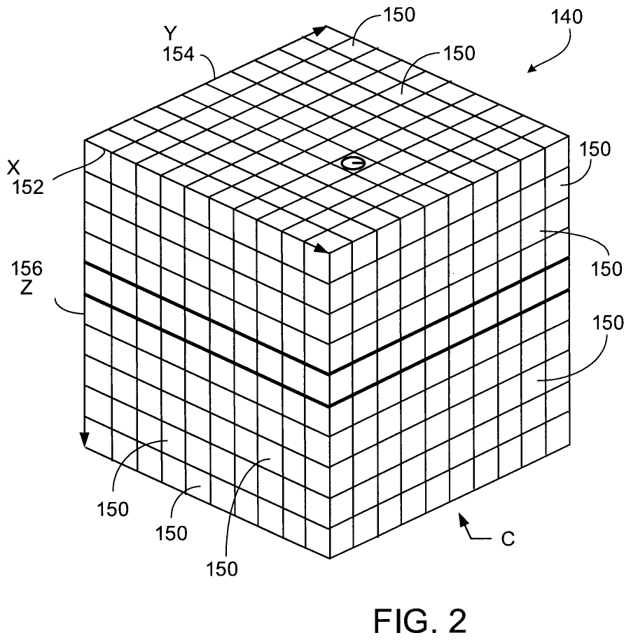

FIG. 2 illustrates a seismic cube 140 representing at least a portion of the subterranean formation 100. The seismic cube 140 is composed of a number of voxels 150. A voxel is a volume element, and each voxel corresponds, for example, with a seismic sample along a seismic trace. The cubic volume C is composed along intersection axes of offset spacing times based on a delta-X offset spacing 152, a delta-Y offset spacing 154, and a delta-Z offset spacing 156. Within each voxel 150, statistical analysis can be performed on data assigned to that voxel to determine, for example, multimodal distributions of travel times and derive robust travel time estimates (according to mean, median, mode, standard deviation, kurtosis, and other suitable statistical accuracy analytical measures) related to azimuthal sectors allocated to the voxel 150. As subsequently described, the imaging condition of the seismic imaging system is configured to perform Hilbert transforms on the vertical delta-Z components of the seismic waves. The seismic cube 200 can be converted to represent acoustic data impendence data, as described in relation to FIG. 1. The volume can be defined around the reservoir in which each voxel includes physical properties of the subsurface such as seismic velocities (our wave propagation model).

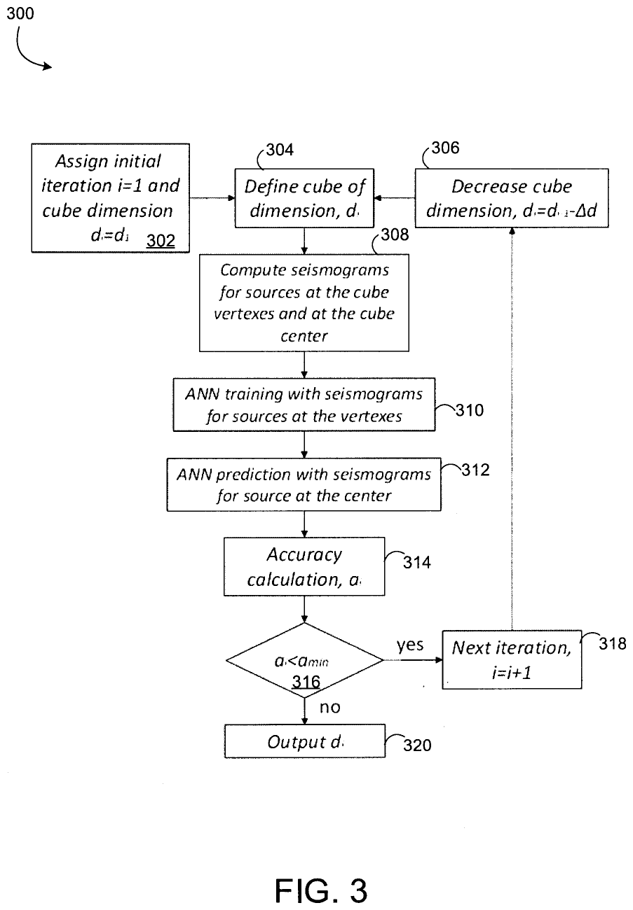

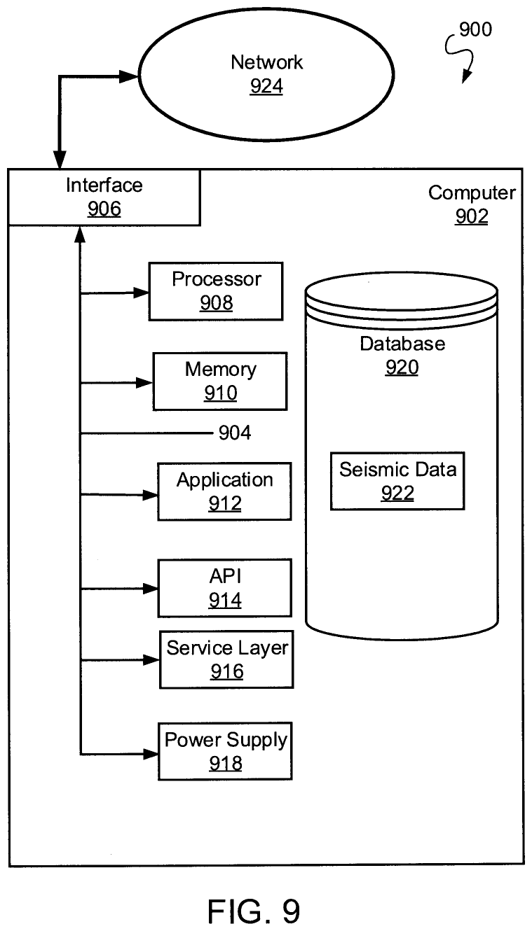

FIG. 3 illustrates a flow diagram including example process 300 for generating an optimized sources distribution for a training dataset enabling a machine learning model to estimate moment tensor components from microseismic data. FIG. 4 shows a data processing system 400 for identifying fracturing trends in the subsurface based on the calculated moment tensor and training data generated by process 300 of FIG. 3. In some implementations, the data processing system 400 is also configured for performing the actions of process 300 of FIG. 3, and can include a computing system 900 described in relation to FIG. 9.

The data processing system 400 includes a data processing engine 414 with a plurality of sub-modules that are configured for performing data processing actions for the data processing system 400. The modules include a machine learning training data generation module 406, a machine learning module 408, and a fractures distribution interpretations module 410.

The data processing engine 414 is configured to receive data including microseismic data 402 from seismic measurements, such as those described in relation to FIG. 1. The data 402 can include possible moment tensor components data, geometry data, and propagation model data. The microseismic measurements are processed by the machine learning training data generation module 406, as described in relation to process 300 in FIG. 3. The module 406 generates training data 412 that can be an input to the machine learning module 408. The machine learning module 408 includes a training sub-module 418 and a prediction generation sub-module 420. The training sub-module 418 receives the training data 412 and trains one or more machine learning models (ANNs). The machine learning models can include any machine learning model, including ANNs such as a deep neural networks (DNNs) or convolutional neural networks (CNNs), and so forth. The machine learning models, once trained, are executed in the prediction generation sub-module 420 to process additional microseismic data 422 acquired on the field. This additional microseismic data is not used as part of the training data. The machine learning module 408, trained by the training data 412, processes microseismic data 422 to generate data 414 including values for components of the moment tensor. These values are processed by the fractures distribution interpretations module 410 to generate mapping data 416, as previously described. The mapping data 416 show fractures probabilities (of orientations) at various locations in the subterranean region, and is generated based on the moment tensor component values 414. The map can be used to guide hydrocarbon exploration and extraction processes, such as fracking processes and/or drilling processes. For example, the data processing system 400 can send a signal to hardware in the field to control drilling or fracking operations based on the mapping data 416.

Turning to FIG. 3, a process 300 is performed by the data processing system 400 once the microseismic data are acquired by a physical acquisition system (such as a part of system described in relation to FIG. 1). One or more sources (such as a source at a borehole) are excited to generate a seismic signal in the formation 100. The seismic signal is propagated through subterranean formation 100 and recorded at receiver(s) (such as receiver 116 of FIG. 1). Generally, the seismic signal is propagated near the surface of the formation 100. Once the seismic data are received, the data processing system 400 can predict through a prediction module 420 the moment tensor component values.

The data processing system, using process 300, is configured to derive a minimum amount of seismic sources that are used to generate the seismograms for the ANN training dataset and provide an acceptable accuracy (such as within a threshold of 75-85%) in the ANN prediction results.

The data processing system performs the inversion of microseismic measurements for retrieving the moment tensor using machine learning (ML), specifically using supervised algorithms such as Artificial Neural Networks (ANNs). The seismograms used to train the network are generated utilizing the discrete-wavenumber method (DWM). The DWM uses a pre-defined wave propagation model and source mechanism. The DWM processes is described in further detail by Bouchon, M. (2003). A Review of the Discrete Wavenumber Method. Pure and Applied Geophysics, 160(3), 445-465, incorporated herein by reference in entirety. A mathematical expression summarizes the relation between the forces inducing the microseismic activity and the generated seismograms is shown as follows in equation 1.

$$u = G m \qquad ( 1 )$$

where u is the vector containing the recorded seismograms, m is the vector of the seismic moment tensor components, and G is the matrix representing the elastic Green's functions. G accounts for propagation effects of the seismic waves travelling through the subsurface. Equation 1 expresses a so-called forward problem, where seismic observations carrying the information about the subsurface (recorded seismograms) are directly predicted from forces yielding the seismic activity. In this example, the forces are represented by the seismic moment tensor. The Green's functions represent a physical link between the moment tensor and the seismic data. Based on application of the DWM, the data processing system could determine elastic Green's functions and the seismograms using different moment tensors characterized by different fault geometries.

The data processing system described in this specification is configured to solve the inverse of the forward problem. The data processing system estimates the moment tensor from recorded seismograms, as previously described. The data processing system performs an inversion of equation (1) to calculate m, with the elastic Green's functions being known, as shown in equation (2).

$$m = {G}^{+} u \qquad ( 2 )$$

wherein G⁺ is the pseudo-inverse of the matrix G.

Generally, computing the pseudo-inverse matrix of the Green's function is complicated and computationally expensive. The data processing system performs inversion of the moment tensor based on using a deep feedforward neural network. The data processing system executes a forward modelling code implementing equation (1). The data processing system simulates the microseismic data generated by several known values of the moment tensor at the source location. The data processing system uses the generated data for training an ANN. The ANN is trained to estimate the moment tensor at the source, given the microseismic data at the seismic receivers.

An advantage of computing the inverse forward problem is that the computational effort of processing is moved before the training phase. This effort occurs when the seismograms are pre-calculated for a given location. To implement a suitable neural network architecture, the data processing system performs a thorough analysis for choosing the best hyper-parameters that lead to the minimum error solution. The data processing system feeds the pre-calculated seismograms to the neural network.

The neural network, being trained, obtains the optimal solution by iteratively updating the network's parameters (also referred to as weights for nodes of the neural network). Training the neural network includes minimizing an error between the input and the calculated output. The associated cost function of the problem and the optimization algorithm are defined when specifying the network's architecture. Once an acceptable error is obtained, the learning process is stopped, and the trained network predicts the seismic moment tensor on new data that is not previously used during the training.

The data processing system is configured for proper selection of the training dataset to be used by the ANN to learn how to predict moment tensor components from microseismic data, artificially generated through modeling. To make this step computationally efficient, the data processing system selects a minimum amount of seismic sources. The seismic sources are distributed in a portion, where microseismic events occur, of the propagation model being analyzed, lately used to generate the seismograms for the ANN training dataset. The selection of sources is difficult in presence of complex heterogeneous velocity models, because it is difficult to capture a sufficient amount of information to describe the seismic wave propagation in these scenarios.

The data processing system automatically generates the ANN training dataset in an efficient way, as previously described. There is a uniform distribution of the seismic sources in the analyzed portion of the velocity model. The data processing system finds a maximum distance dₘₐₓ between such sources that results in an acceptable minimum accuracy aₘᵢₙ of the ANN prediction results (e.g., within 75-85% of the actual value). This maximum distance corresponds to the minimum amount of seismic sources, to the minimum amount of seismograms to be generated for the ANN training dataset and therefore to the minimum computational cost. The maximum distance can be obtained following the process 300 of FIG. 3.

For process 300, the data processing system 300 is configured to assign (302) an initial iteration and cube dimension dᵢ=d₁ and a corresponding cube of dimension d₁, which is big enough to cover the entire portion of the velocity model (a portion of the subsurface). An example cube 608, 610 is shown in FIG. 5, subsequently described. A center of the cube corresponds to a center of the velocity model portion.

The data processing system simulates seismic sources 604a-h at the 8 vertices of such a cube 610 (or sources 602a-h of cube 608). A further source 606 is placed at the center of the cube 608, 610 (depending on the iteration). The data processing system simulates (308) seismic wave propagation from such sources 604a-h to the seismic receivers (not shown) for several known values of the moment tensor components.

The data processing system uses the seismograms generated by the sources 604a-g at the vertexes of the cube are used to train (310) a machine learning model, such as an ANN, as previously described. For example, the weight of the ANN are adjusted based on the known values of the moment tensor components and the corresponding seismogram data values.

The data processing system, based on the trained machine learning model, predicts (312) values of the moment tensor components from the seismograms generated by the source 606 at the center of the cube 610. The data processing system computes (314) the estimation accuracy al representing the accuracy of the prediction. The data processing system compares (316) the determined accuracy value to a threshold accuracy value. If the accuracy is lower than an acceptable pre-defined value aₘᵢₙ, the data processing system stops (320) the procedure, and d₁ becomes the required maximum distance between the seismic sources 604a-g. Otherwise, the data processing system iterates (318) to a next calculation iteration. The data processing system reduces (306) the maximum distance and the corresponding cube 608 dimension (always with center 606 corresponding to the center of the velocity model portion). The data processing system reduces the dimension dᵢ by a pre-defined value Δd. Cube 608 and sources 602a-g represent reduced dimension of the velocity model portion, centered at source 606. The data processing system repeats steps 304, 308, 310, 312, 314, and 316 for the new value d2.

The procedure 300 is iterated until the optimal distance/dimension dₘₐₓ is found based on the accuracy satisfying the threshold aₘᵢₙ. In some implementations, different measures of the ANN prediction accuracy can be used, for example the normalized accuracy (best accuracy for a=1), shown in equation (3):

$$a = 1 - \frac{{\sum }_{l = 1}^{L} {\sum }_{n = 1}^{N} {( {m}_{l , n} - {{m}_{l , n}}^{\text{?}} )}^{2}}{{\sum }_{l = 1}^{L} {\sum }_{n = 1}^{N} {( {m}_{l , n} - \overline{{m}_{l , n}} )}^{2}} \qquad ( 3 )$$

$$\text{?} \text{indicates text missing or illegible when filed}$$

with L the number of seismograms (or different moment tensor values) used for the prediction, N the dimension of the moment tensor (in general we have a maximum of 6 independent components), m_{l,n} and [symbol] the true and predicted moment tensor components and m̅_̅{̅l̅,̅n̅}̅ defined as the average in equation (4). Equation (4) is shown:

$$\overline{{m}_{l , n}} = \frac{1}{N} {\sum }_{n = 1}^{N} {m}_{l , n} \qquad ( 4 )$$

At the end of the procedure, a set of seismic sources 602a-g are uniformly distributed in the velocity model portion and equally separated in all directions by the distance dₘₐₓ and are defined by the data processing system. The data processing system generates seismograms forming the optimal ANN training dataset from these sources 602a-g.

The maximum dimension dₘₐₓ controls a number of simulations and therefore computational time. A larger dimension is better for reducing computational cost. However, to achieve a minimum accuracy, a dₘₐₓ is identified. During the ANN training phase the data processing system first estimates dₘₐₓ and then, based on the value of dₘₐₓ, generates a set of microseismic sources with different moment tensor components. After simulation, the data processing system generates a set of corresponding microseismic data. The pairs (moment tensor components, microseismic data) are used to train the ANN. After the training, the ANN can be applied on field data to predict (almost instantaneously) the moment tensor components of the microseismic sources from the microseismic data. If the synthetic model used in the simulations is good enough to characterize the subsurface, the estimations in the field are accurate.

FIG. 5 shows velocity model cubes 608, 610 that are computed by the data processing system in process 300. The cube 608 shows an effect of a reduction of the cube 610 dimension as previously described. The sources 602a-g and center source 606 are the seismic sources, respectively, at the vertexes and at the center of the cubes 608, 610.

The data processing system can test the predictive capabilities of the generated machine learning model for realistic borehole acquisition geometries, heterogeneous wave propagation models (such as SEAM Arid model—Oristaglio, 2015), and multiple microseismic sources distributed along a three-dimensional space. The data processing system retrieves the six-independent components of the seismic moment tensor with good accuracy (e.g., better than 75-85% accuracy) when using noise-contaminated seismograms and complex source mechanisms (such as a non-double-couple). The latter mechanisms are characterized by a combination of shear and normal seismic displacements with respect to the fault plane. This is generally the case when inducing microseismic activity in hydraulic fracturing. As an example, to demonstrate the capabilities of the proposed approach for inverting microseismic data to retrieve the seismic moment tensor, a geometry setup of a realistic borehole acquisition survey with a horizontal well is defined as shown in FIG. 6.

FIG. 6 shows a borehole seismic acquisition geometry 700 with a horizontal well. Receiver stations 704 form a line in the well. Points 702 represent the events used for training the ANN. The points 706 are the events whose unknown moment tensor needs to be estimated using the trained ANN.

The three-component receiver stations 704 are positioned at a 2 kilometer (km) depth with a spacing of 25 meters (m) between them, covering a distance of 500 m and spreading in the North-South direction. The microseismic events are positioned 300-400 m aside of the horizontal well in the West-East direction. To decide their spatial distribution, the data processing system executes process 300. The data processing system obtains a maximum distance of 25 m. The data processing system then uses the seismic information generated by the events 702 in the geometry to predict the moment-tensor components for events 706 not previously seen by the network.

Using the previously described geometry, the data processing system generates noise-contaminated seismograms using moment tensors describing different fault geometries for multiple microseismic sources of different magnitudes. This is done for training purposes so that the neural network can recognize several source mechanisms, thus compensating for the lack of angle coverage usually encountered in field applications.

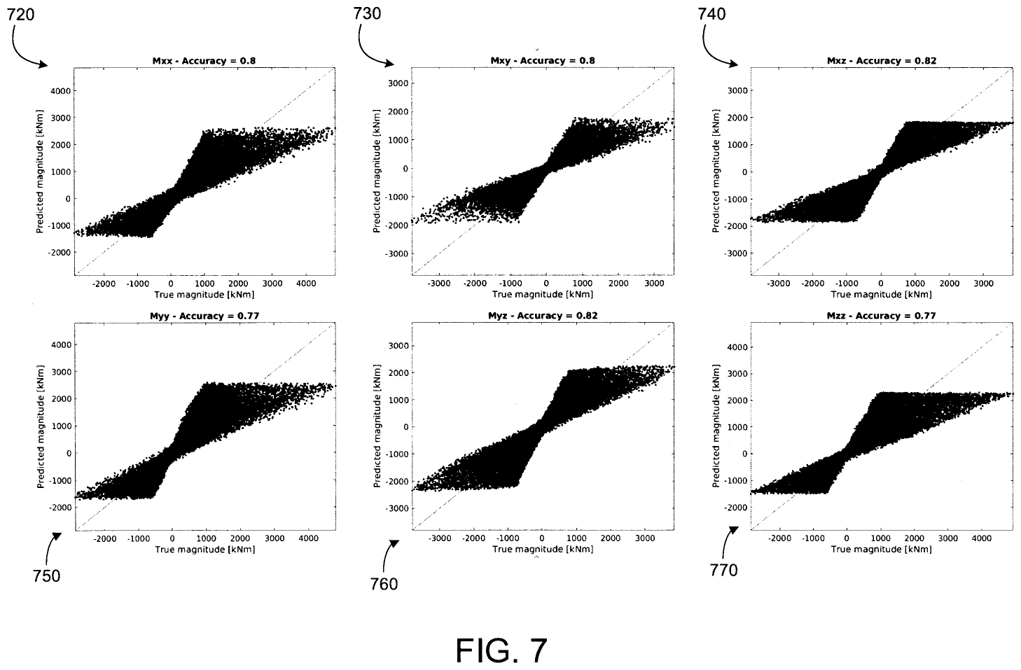

FIG. 7 includes graphs 720, 730, 740, 750, 760, and 770 including results of the predicted six-independent moment-tensor components. The seismograms utilized to perform the prediction are generated by a microseismic event not used during the learning phase. The ANN yields satisfactory results when predicting the components of the seismic moment tensor even in the presence of noise. The magnitude of the true/predicted values depends on the geometry, magnitude, and location of the microseismic event. Similar results are obtained by predicting the moment tensor components of all the events 706 in FIG. 6. The results 720-770 of the test therefore show how the data processing system, executing process 300, successfully determines a best spatial distribution of the seismic sources to be used for the ANN training phase.

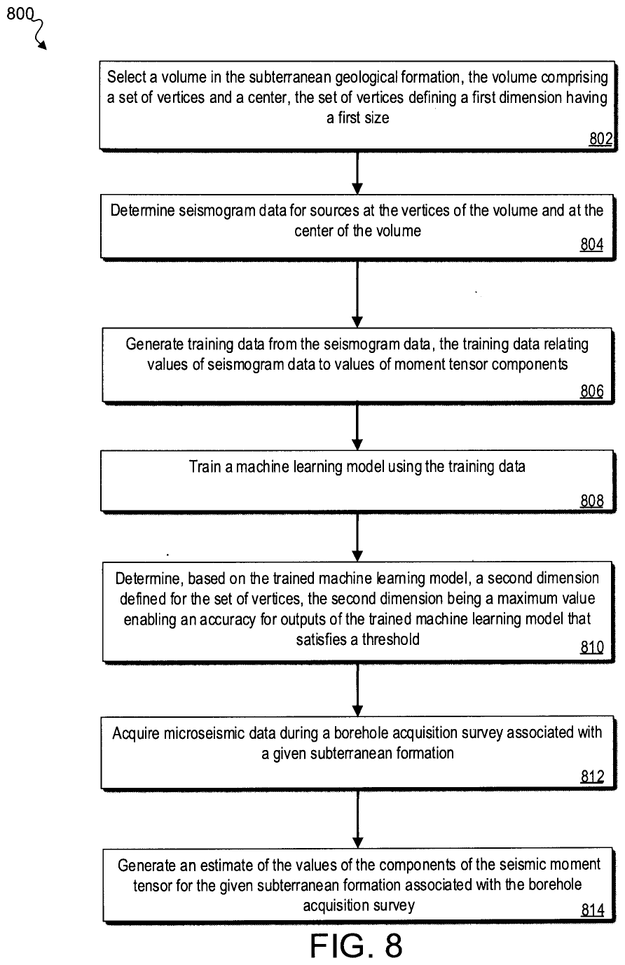

FIG. 8 shows an example process 800 for generating a training dataset enabling a machine learning model to estimate moment tensor components from microseismic data. In some implementations, process 800 is similar to process 300 performed by the data processing system. Process 800 for training a machine learning model to process microseismic data recorded during fracturing of a subterranean geological formation includes selecting (802) a volume in the subterranean geological formation, the volume comprising a set of vertices and a center, the set of vertices defining a first dimension. The process 800 includes determining (804) seismogram data for sources at the vertices of the volume and at the center of the volume. The process includes generating (806) training data from the seismogram data, the training data relating values of seismogram data to values of moment tensor components. The process 800 includes training (808) a machine learning model using the training data. The process includes determining (810), based on the trained machine learning model, a second dimension defined for the set of vertices, the second dimension being a maximum value enabling an accuracy for outputs of the trained machine learning model that satisfies a threshold.

The process 800 includes acquiring (812) microseismic data during a borehole acquisition survey associated with a given subterranean formation. The process 800 includes executing the trained machine learning model on the microseismic data. The process includes generating an estimate of the values of the components of the moment tensor components for the given subterranean formation associated with the borehole acquisition survey.

The process 800 includes generating a seismic interpretation based on the estimate of the values of the components of the moment tensor components. The process 800 includes drilling a well in the given subterranean formation or performing hydraulic fracturing in the given subterranean formation based on the estimate of the values of the components of the moment tensor components.

The process 800 includes generating training data from the seismogram data comprises simulating seismic wave propagation from the sources to the receivers for one or more known values of the moment tensor components.

The process 800 includes training the machine learning model using the training data comprises setting weight values of nodes represented in a neural network of the machine learning model.

FIG. 9 is a block diagram of an example computing system 900 used to provide computational functionalities associated with described algorithms, methods, functions, processes, flows, and procedures described in the present disclosure, according to some implementations of the present disclosure. The illustrated computer 902 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 902 can include input devices such as keypads, keyboards, and touch screens that can accept user information. Also, the computer 902 can include output devices that can convey information associated with the operation of the computer 902. The information can include digital data, visual data, audio information, or a combination of information. The information can be presented in a graphical user interface (UI) (or GUI).

The computer 902 can serve in a role as a client, a network component, a server, a database, a persistency, or components of a computer system for performing the subject matter described in the present disclosure. The illustrated computer 902 is communicably coupled with a network 924. In some implementations, one or more components of the computer 902 can be configured to operate within different environments, including cloud-computing-based environments, local environments, global environments, and combinations of environments.

At a high level, the computer 902 is an electronic computing device operable to receive, transmit, process, store, and manage data and information associated with the described subject matter. According to some implementations, the computer 902 can also include, or be communicably coupled with, an application server, an email server, a web server, a caching server, a streaming data server, or a combination of servers.

The computer 902 can receive requests over network 924 from a client application (for example, executing on another computer 902). The computer 902 can respond to the received requests by processing the received requests using software applications. Requests can also be sent to the computer 902 from internal users (for example, from a command console), external (or third) parties, automated applications, entities, individuals, systems, and computers.

Each of the components of the computer 902 can communicate using a system bus 904. In some implementations, any or all of the components of the computer 902, including hardware or software components, can interface with each other or the interface 906 (or a combination of both), over the system bus 904. Interfaces can use an application programming interface (API) 914, a service layer 916, or a combination of the API 914 and service layer 916. The API 914 can include specifications for routines, data structures, and object classes. The API 914 can be either computer-language independent or dependent. The API 914 can refer to a complete interface, a single function, or a set of APIs.

The service layer 916 can provide software services to the computer 902 and other components (whether illustrated or not) that are communicably coupled to the computer 902. The functionality of the computer 902 can be accessible for all service consumers using this service layer. Software services, such as those provided by the service layer 916, can provide reusable, defined functionalities through a defined interface. For example, the interface can be software written in JAVA, C++, or a language providing data in extensible markup language (XML) format. While illustrated as an integrated component of the computer 902, in alternative implementations, the API 914 or the service layer 916 can be stand-alone components in relation to other components of the computer 902 and other components communicably coupled to the computer 902. Moreover, any or all parts of the API 914 or the service layer 916 can be implemented as child or sub-modules of another software module, enterprise application, or hardware module without departing from the scope of the present disclosure.

The computer 902 includes an interface 906. Although illustrated as a single interface 906 in FIG. 9, two or more interfaces 906 can be used according to particular needs, desires, or particular implementations of the computer 902 and the described functionality. The interface 906 can be used by the computer 902 for communicating with other systems that are connected to the network 924 (whether illustrated or not) in a distributed environment. Generally, the interface 906 can include, or be implemented using, logic encoded in software or hardware (or a combination of software and hardware) operable to communicate with the network 924. More specifically, the interface 906 can include software supporting one or more communication protocols associated with communications. As such, the network 924 or the hardware of the interface can be operable to communicate physical signals within and outside of the illustrated computer 902.

The computer 902 includes a processor 908. Although illustrated as a single processor 908 in FIG. 9, two or more processors 908 can be used according to particular needs, desires, or particular implementations of the computer 902 and the described functionality. Generally, the processor 908 can execute instructions and can manipulate data to perform the operations of the computer 902, including operations using algorithms, methods, functions, processes, flows, and procedures as described in the present disclosure.

The computer 902 also includes a database 920 that can hold data (for example, seismic data 922) for the computer 902 and other components connected to the network 924 (whether illustrated or not). For example, database 920 can be an in-memory, conventional, or a database storing data consistent with the present disclosure. In some implementations, database 920 can be a combination of two or more different database types (for example, hybrid in-memory and conventional databases) according to particular needs, desires, or particular implementations of the computer 902 and the described functionality. Although illustrated as a single database 920 in FIG. 9, two or more databases (of the same, different, or combination of types) can be used according to particular needs, desires, or particular implementations of the computer 902 and the described functionality. While database 920 is illustrated as an internal component of the computer 902, in alternative implementations, database 920 can be external to the computer 902.

The computer 902 also includes a memory 910 that can hold data for the computer 902 or a combination of components connected to the network 924 (whether illustrated or not). Memory 910 can store any data consistent with the present disclosure. In some implementations, memory 910 can be a combination of two or more different types of memory (for example, a combination of semiconductor and magnetic storage) according to particular needs, desires, or particular implementations of the computer 902 and the described functionality. Although illustrated as a single memory 910 in FIG. 9, two or more memories 910 (of the same, different, or combination of types) can be used according to particular needs, desires, or particular implementations of the computer 902 and the described functionality. While memory 910 is illustrated as an internal component of the computer 902, in alternative implementations, memory 910 can be external to the computer 902.

The application 912 can be an algorithmic software engine providing functionality according to particular needs, desires, or particular implementations of the computer 902 and the described functionality. For example, application 912 can serve as one or more components, modules, or applications. Further, although illustrated as a single application 912, the application 912 can be implemented as multiple applications 912 on the computer 902. In addition, although illustrated as internal to the computer 902, in alternative implementations, the application 912 can be external to the computer 902.

The computer 902 can also include a power supply 918. The power supply 918 can include a rechargeable or non-rechargeable battery that can be configured to be either user-or non-user-replaceable. In some implementations, the power supply 918 can include power-conversion and management circuits, including recharging, standby, and power management functionalities. In some implementations, the power-supply 918 can include a power plug to allow the computer 902 to be plugged into a wall socket or a power source to, for example, power the computer 902 or recharge a rechargeable battery.

There can be any number of computers 902 associated with, or external to, a computer system containing computer 902, with each computer 902 communicating over network 924. Further, the terms “client,” “user,” and other appropriate terminology can be used interchangeably, as appropriate, without departing from the scope of the present disclosure. Moreover, the present disclosure contemplates that many users can use one computer 902 and one user can use multiple computers 902.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Any claimed implementation is considered to be applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory, computer-readable medium.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

What is claimed is:

1. A method for training a machine learning model to process microseismic data recorded during fracturing of a subterranean geological formation, the method comprising:
selecting a volume in the subterranean geological formation, the volume comprising a set of vertices and a center, the set of vertices defining a first dimension;
determining seismogram data for sources at the vertices of the volume and at the center of the volume;
generating training data from the seismogram data, the training data relating values of seismogram data to values of moment tensor components;
training a machine learning model using the training data; and
determining, based on the trained machine learning model, a second dimension defined for the set of vertices, the second dimension being a maximum value enabling an accuracy for outputs of the trained machine learning model that satisfies a threshold.

2. The method of claim 1, further comprising:
acquiring microseismic data during a borehole acquisition survey associated with a given subterranean formation;
executing the trained machine learning model on the microseismic data; and
generating an estimate of the values of the moment tensor components for the given subterranean formation associated with the borehole acquisition survey.

3. The method of claim 2, further comprising generating a seismic based on the estimate of the values of the moment tensor components.

4. The method of claim 2, further comprising:
drilling a well in the given subterranean formation or performing hydraulic fracturing in the given subterranean formation based on the estimate of the values of the moment tensor components.

5. The method of claim 1, wherein generating training data from the seismogram data comprises simulating seismic wave propagation from the sources to the receivers for one or more known values of the moment tensor components.

6. The method of claim 1, wherein training the machine learning model using the training data comprises setting weight values of nodes represented in a neural network of the machine learning model.

7. A system for training a machine learning model to process microseismic data recorded during fracturing of a subterranean geological formation, the system comprising:
at least one processor; and
a memory storing instructions that, when executed by the at least one processor, cause the at least one processor to perform operations comprising:
selecting a volume in the subterranean geological formation, the volume comprising a set of vertices and a center, the set of vertices defining a first dimension;
determining seismogram data for sources at the vertices of the volume and at the center of the volume;
generating training data from the seismogram data, the training data relating values of seismogram data to values of moment tensor components;
training a machine learning model using the training data; and
determining, based on the trained machine learning model, a second dimension defined for the set of vertices, the second dimension being a maximum value enabling an accuracy for outputs of the trained machine learning model that satisfies a threshold.

8. The system of claim 7, the operations further comprising:
acquiring microseismic data during a borehole acquisition survey associated with a given subterranean formation;
executing the trained machine learning model on the microseismic data; and
generating an estimate of the values of the moment tensor components for the given subterranean formation associated with the borehole acquisition survey.

9. The system of claim 8, the operations further comprising generating a seismic based on the estimate of the values of the moment tensor components.

10. The system of claim 8, the operations further comprising:
drilling a well in the given subterranean formation or performing hydraulic fracturing in the given subterranean formation based on the estimate of the values of the moment tensor components.

11. The system of claim 7, wherein generating training data from the seismogram data comprises simulating seismic wave propagation from the sources to the receivers for one or more known values of the moment tensor components.

12. The system of claim 7, wherein training the machine learning model using the training data comprises setting weight values of nodes represented in a neural network of the machine learning model.

13. One or more non-transitory computer-readable media storing instructions for training a machine learning model to process microseismic data recorded during fracturing of a subterranean geological formation, the instructions, when executed by at least one processor, cause the at least one processor to perform operations comprising:
selecting a volume in the subterranean geological formation, the volume comprising a set of vertices and a center, the set of vertices defining a first dimension;
determining seismogram data for sources at the vertices of the volume and at the center of the volume;
generating training data from the seismogram data, the training data relating values of seismogram data to values of moment tensor components;
training a machine learning model using the training data; and
determining, based on the trained machine learning model, a second dimension defined for the set of vertices, the second dimension being a maximum value enabling an accuracy for outputs of the trained machine learning model that satisfies a threshold.

14. The one or more non-transitory computer-readable media of claim 13, the operations further comprising:
acquiring microseismic data during a borehole acquisition survey associated with a given subterranean formation;
executing the trained machine learning model on the microseismic data; and
generating an estimate of the values of the moment tensor components for the given subterranean formation associated with the borehole acquisition survey.

15. The one or more non-transitory computer-readable media of claim 14, the operations further comprising generating a seismic based on the estimate of the values of the moment tensor components.

16. The one or more non-transitory computer-readable media of claim 14, the operations further comprising:
drilling a well in the given subterranean formation or performing hydraulic fracturing in the given subterranean formation based on the estimate of the values of the moment tensor components.

17. The one or more non-transitory computer-readable media of claim 13, wherein generating training data from the seismogram data comprises simulating seismic wave propagation from the sources to the receivers for one or more known values of the moment tensor components.

18. The one or more non-transitory computer-readable media of claim 13, wherein training the machine learning model using the training data comprises setting weight values of nodes represented in a neural network of the machine learning model.
